(19) United States
(12) Patent Application Publication
(10) Pub. No.: US 2026/0150994 A1
(43) Pub. Date: Jun. 4, 2026

(54) Egg Cooking Machine

(71) Applicant: Andras Galfi, Mission Viejo, CA (US)

(72) Inventor: Andras Galfi, Mission Viejo, CA (US)

(21) Appl. No.: 18/965,733

(22) Filed: Dec. 2, 2024

(51) Int. Cl. A47J 29/02; A47J 37/08

(52) U.S. Cl. CPC A47J 29/02; A47J 37/08

(57) ABSTRACT

An egg cooking machine has an egg receiver assembly with an upper portion and a lower portion that together form an internal chamber. The egg receiver assembly may be opened for inserting an egg, and the lower portion has a discharge tube with a puncture end that punctures the egg and extends downwardly from the puncture end to a discharge end for passage of the contents of the egg. An air inlet tube has a puncture end that punctures the egg when it is positioned within the internal chamber and the upper portion is closed, and the air inlet tube extends to a lower end that communicates with the discharge tube. A pneumatic system forces the passage of the egg onto a tray. A heating element is positioned adjacent the tray for cooking the egg after it has been dispensed.

### FIELD OF THE INVENTION

This invention relates generally to kitchen appliances, and more particularly to an egg cooking machine that is adapted to automatically extract and cook an egg.

### DESCRIPTION OF RELATED ART

J. Meade, U.S. Pat. No. 2,445,490, teaches a machine for puncturing eggs and applying a vacuum for removing the content of eggs from the shells thereof. The invention consists in piercing or puncturing the egg through the shell at two opposite points and simultaneously applying vacuum suction at one puncture so as to cause the liquid content of said egg to discharge thereat under compulsion of atmospheric pressure applied at the other puncture. This system is used, however, for bulk extraction of eggs for food processing, and is not used in conjunction with any cooking operation.

Reed, U.S. Pat. No. 4,182,234, teaches a non-destructing eggshell egg contents remover that used vacuum to remove the egg, in a process called egg blowing. The system incorporates an egg receiving assembly incorporating an egg cup receptacle having a soft resilient hollow concave recess for placement of an egg therein. Protruding through the bottom portion of the egg receiving assembly is a pair of tubes, an egg contents discharge tube for receiving the extracted contents of the egg and an air inlet tube for forcing compressed air into the egg causing its contents to be removed through the discharge tube. The egg is simply sucked into a bowl, it is not used as part of a cooking process. Indeed, the point of this system is to obtain unbroken eggshells, for decorating and such, not for using the actual egg contents.

Lentini, U.S. Pat. No. 11,992,146, teaches an egg cooking device that includes a storage component for storing raw eggs, a cracking component configured receive a raw egg of one of the stored eggs, and a hot plate configured to receive the cracked egg from the cracking component and cook the cracked egg, forming a cooked egg, and a warming component configured to receive the cooked egg from the cooking component and warm the cooked egg. While Lentini does teach the process of cooking an egg following extraction, it uses an entirely different process, and is so large and cumbersome that it appears fairly impractical.

Lee, U.S. Pat. No. 10,702,089, teaches an egg cooking system which includes two woks and each of the

woks receives oil from an oil supply member. A support member is driven by a driving unit to allow one egg to be put in the at least one standby portion and the egg is pressed by the pressing member. A cracking member cracks the egg and the pressing unit moves toward the direction that the egg is located so that a claw is opened, and the egg flows into one of the woks. The egg is cooked for a pre-set time, and is dropped into the other wok to be cooked. The cooked egg is then dropped to a plate. The pressing unit presses the eggshell of the egg to further open the claw, and the eggshell drops into a garbage can.

Zhou, U.S. 20240225368, teaches an automatic egg frying machine that includes a fairly complicated machine that includes an egg placing device, an egg delivery device, a moving assembly, an egg cracking/opening device, a cooking device and a rotary receiving plate device are arranged in the machine frame. The cooking device includes a frying pan, the egg opening device includes an egg supporting portion, a trigger portion and an egg knife, and the trigger portion includes egg receiving position a, egg cracking position b, egg opening position c and shell dropping position e. The moving device is arranged on one side of the egg opening device, and the egg opening device completes the actions of egg receiving, egg cracking from a side surface, egg opening and shell dropping in one direction by means of the moving device, such that hands are freed.

While using pneumatics to remove egg contents is known, this is used for commercial production (J. Meade), or for preparing unbroken eggshells (Reed), not for sending the egg contents into a tray for immediate and automatic cooking.

A major novelty of the present invention is its great simplicity, a single egg being placed in a receiver, like a Keurig machine, removing the need for a feed system. A single cooking process enables the user of a simple disposable cooking tray, which would not be practical in a larger scale operation. The present invention fulfills these needs and provides further advantages as described in the following summary.

### SUMMARY OF THE INVENTION

The present invention teaches certain benefits in construction and use which give rise to the objectives described below.

The present invention provides an egg cooking machine for receiving, extracting, and cooking a single egg. The egg cooking machine comprises an egg receiver assembly having an upper portion and a lower portion that together form an internal chamber, wherein egg receiver assembly may be opened for inserting the egg into the internal chamber. The lower portion includes a discharge tube has a puncture end that punctures the egg when it is inserted into the internal chamber, the discharge tube extending downwardly from the puncture end to a discharge end for passage of the contents of the egg. An air inlet tube extends inwardly from the upper portion of the internal chamber, the air inlet tube having a puncture end that punctures the egg when it is positioned within the internal chamber and the upper portion is closed, and wherein the air inlet tube extends from the puncture end to a lower end that communicates with the discharge tube for passage of gas into the egg. A pneumatic system, interconnected with the air inlet tube, forces the passage of gas into the egg, and a tray is positioned beneath the discharge end of the discharge tube for catching the content of the egg after being pneumatically forced out of the egg's shell and dispensed out of the discharge tube. A heating element of the tray cooks the egg after it has been dispensed out of the discharge tube.

A primary objective of the present invention is to provide an egg cooking machine having advantages not taught by the prior art.

Another objective is to provide an egg cooking machine that receives, extracts, and cooks a single egg within a closed system.

A further objective is to provide an egg cooking machine that may be combined with other appliances to prepare multiple items at once for consumption.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention.

FIG. 1 is a perspective view of an egg cooking machine according to one embodiment of the present invention;

FIG. 2 is a perspective view of an egg receiver assembly of the egg cooking machine in an open configuration, showing an egg being inserted into the egg receiver; and

FIG. 3 is a sectional view of the egg receiver assembly in a closed configuration and further showing a pneumatic system and a cooking mechanism.

### DETAILED DESCRIPTION OF THE INVENTION

The above-described drawing figures illustrate the invention, an egg cooking machine that is adapted to automatically puncture and cook a single egg.

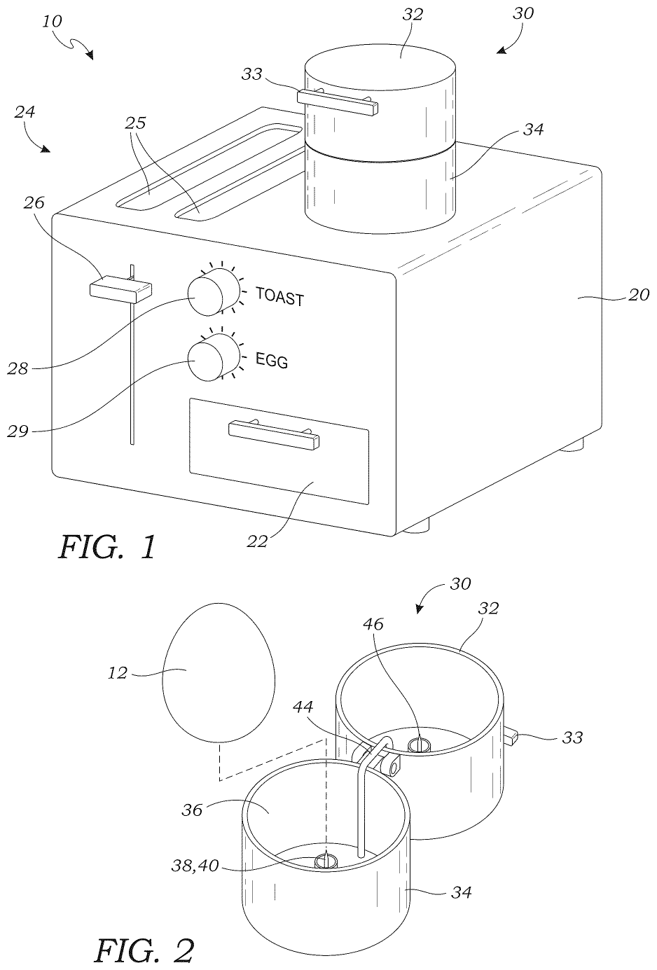

FIG. 1 is a perspective view of an egg cooking machine 10 according to one embodiment of the present invention. As shown in FIG. 1, the egg cooking machine 10 may be integrated into a kitchen appliance for multipurpose use, in this embodiment being a toaster. However, in other embodiments, the egg cooking machine 10 may be integrated into a different appliance, or it may be constructed as a singular product. As illustrated, the egg cooking machine 10 comprises an egg receiver assembly 30 for receiving a single egg, in this embodiment being mounted on a housing 20 having a toaster assembly 24 and a door 22 for retrieving the egg after it has been cooked.

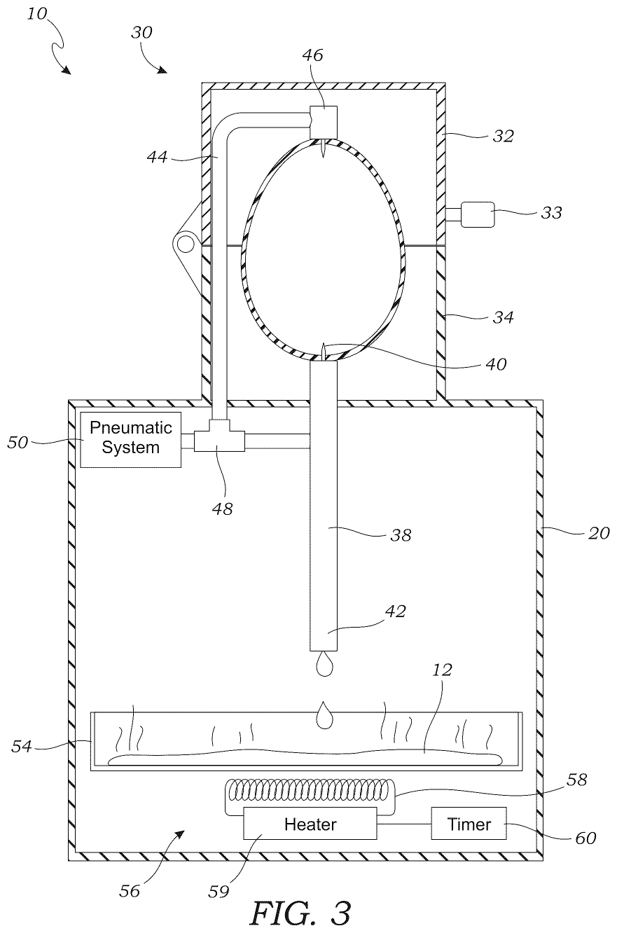

While the housing 20 of FIG. 1 is illustrated as being generally rectangular, it should be understood that any suitable form of housing may be implemented, in any desired shape, provided it is compatible with the invention as-claimed. In this embodiment, the toaster assembly 24 of the housing 20 includes a pair of bread slots 25 and a toaster lever 26 for toasting bread or other consumables (not shown). As illustrated, the housing 20 may further include a toaster dial 28 for controlling the cook time of the toaster, and an egg dial 29 for controlling the cook time of the egg cooking machine 10. In other embodiments, the dials may be in the form of buttons, levers, a touch screen, or other means of controlling cook time. In this embodiment, the door 22 for retrieving the cooked egg is in the form of hinged door, but the door 22 may alternatively be a drawer, slide-covering, or other form of openable closure. The internal components of the egg cooking machine 10 are best shown in FIGS. 2-3 and discussed below.

FIG. 2 is a perspective view of the egg receiver assembly 30 of the egg cooking machine 10 in an open configuration, showing an egg 12 being inserted into the egg receiver, and FIG. 3 is a sectional view of the egg receiver assembly 30 in a closed configuration and further showing a pneumatic system 50 and a cooking mechanism 52. As shown in FIGS. 2-3, the egg cooking machine 10 is adapted to receive, extract, and cook the egg 12.

In various embodiments, the egg receiver assembly 30 has an upper portion 32 and a lower portion 34 that together form an internal chamber 36, wherein egg receiver assembly 30 may be opened for inserting the egg 12 into the internal chamber 36. The upper and lower portions 32 and 34 may be hingeably attached, or may be attached via a different means, or fully separable. As shown in the drawings, the upper portion 32 may include a handle 33 for opening the egg receiver assembly 30. The lower portion 34 includes a discharge tube 38 having a puncture end 40 that punctures the egg 12 when it is inserted into the internal chamber 36, the discharge tube 38 extending downwardly from the puncture end 40 to a discharge end 42 for passage of the contents of the egg 12. An air inlet tube 44 extends inwardly from the upper portion 32 of the internal chamber 36, the air inlet tube 44 having a puncture end 46 that punctures the egg 12 when it is positioned within the internal chamber 36 and the upper portion 32 is closed, and wherein the air inlet tube 44 extends from the puncture end 46 to a lower end 48 that communicates with the discharge tube 38 for passage of gas into the egg 12.

As illustrated, in this embodiment, the puncture ends 40 and 46 of the discharge tube 38 and the air inlet tube 44 are each in the form of a hollow needle, but any means of puncturing may be included. For example, a plurality of hollow needles, or claws positioned around the perimeter of the tubular end, etc. In some embodiments, the hollow needles may be retractable, so that the egg 12 may be positioned on the puncture end 40 without puncturing, and then the needles extend into the egg 12 after the upper portion 32 is closed. This may be performed via a retraction mechanism such as a switch or dial, or alternatively may be automatic when the upper portion 32 is hinged downwardly.

The pneumatic system 50 may be interconnected with the air inlet tube 44 for forcing the passage of gas into the egg 12, and/or a vacuum for sucking the egg out of the discharge tube 38. In this embodiment, the pneumatic system 50 is located beneath the egg receiver assembly 30, within the housing 20, but it may be located in any location, including above or adjacent the egg receiver assembly 30 and/or outside of the housing 20. The pneumatic system 50 may be actuated by the closure of the upper portion 32 of the egg receiver assembly 30, by the egg dial 29 shown in FIG. 1, or by another means, e.g., a button, switch, etc., located anywhere accessible to the user.

As shown in FIG. 3, the cooking mechanism 52 of the egg cooking machine 10 includes a tray 54, a heating element 56 that is positioned adjacent the tray 54 when the tray 54 is positioned within a receiving portion of the housing 20. The tray 54 is positioned beneath the discharge end 42 of the discharge tube 38 for catching the content of the egg 12 after being pneumatically forced out of the egg's shell and dispensed out of the discharge tube 38. In some embodiments, the tray 54 is disposable and replaceable for single-use cooking. The tray 54 may be constructed of aluminum foil, steel, or any other material that may be used as a cooking surface. In one embodiment, the tray 54 is constructed of thin aluminum foil suitable for single use and then disposal. Alternatively, the tray 54 may be adapted for multiple uses, wherein it may be removable for cleaning in between uses. For purposes of this application, the term “disposable” is defined to mean that it is thin enough and inexpensive enough so that one skilled in the art would consider it suitable for single use and then disposal. The tray may be sized and shaped for cooking a single egg, in this embodiment 2.5-6 inches in width and depth, in this case approximately 4 by 4 inches square (or round, or other suitable shape).

The tray 54 may be positioned on a slidable rack (not shown), wherein once the egg 12 is cooked by the heating element 56, the door 22 of the housing 20 may be opened, and the rack may be slid outwardly to retrieve the tray 54/cooked egg. Alternatively, the tray 54 may simply be positioned on top of a fixed support surface, or directly on top of the heating element 56.

The heating element 56 heats the tray 54 for cooking the egg 12 after it has been dispensed out of the discharge tube 38. The heating element 56 may include heat-conducting coils 58 and an electric heater 59, or alternatively may be any form of heating element, e.g., a gas flame, flat panel heater, etc., as long as it is sufficient for cooking the egg 12. The heater may be actuated by the egg dial 29 of FIG. 1, wherein the timer 60 determines the amount of time the heater is conducting heat into the coils 58. Alternatively, the heater may be actuated via another means, e.g., a switch to transfer gas for lighting from a pilot light, a button, etc., which should be considered within the scope of the present invention. In various embodiments, the timer 60 automatically stops the cooking of the egg 12 after a predetermined time, so different levels of cooking may be selected, as desired by the user.

In some embodiments, the egg cooking machine 10 may be electrically powered by a direct connection (i.e., a cord, plug, and wall outlet), or it may alternatively be battery-powered, using any form of battery known in the art. In some embodiments, the battery may be solar-powered for outdoor use, or include charging coils for being charged by a separate device. Any form of powering the egg cooking machine 10 may be included, as determined by one skilled in the art.

In use, a user first opens the upper portion 32 of the egg receiver assembly 30 and places the egg 12 on top of the puncture end 40 of the discharge tube 38 before closing the upper portion 32, wherein the puncture ends 40 and 46 of the discharge tube 38 and the air inlet tube 44 puncture the egg 12. The user may then use the egg dial 29 to set the timer 60 to actuate the pneumatic system 50 and the heating element 56, or the pneumatic system 50 may alternatively be actuated via a different means. The pneumatic system 50 injects air/gas from the air inlet tube 44 into the egg 12, and creates a vacuum from the discharge tube 38, which pumps the contents of the egg 12 out of the shell, down the discharge tube 38, and onto the tray 54 for cooking by the heating element 56. The timer 60 may signal that the egg 12 is cooked after the predetermined cook time has passed (i.e., an audible signal, flashing light, and/or similar), or it may simply stop the heater from heating the tray 54. The user may then open the door 22 of the housing 20 to retrieve the cooked egg from the tray 54.

In some embodiments, the toaster may be used at the same time as the egg 12, so both toast and the egg 12 may be ready for consumption at the same time. The egg cooking machine 10 provides a simple, compact, and practical means for cooking a single egg, without the need for a feed system, bulk processing, or separate cooking. In some uses, the user may also wish to retrieve the intact eggshell from the egg receiver assembly 30 for any desired purpose, such as for decorating.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. An egg cooking machine for receiving, extracting, and cooking an egg, the egg cooking machine comprising:
an egg receiver assembly having an upper portion and a lower portion that together form an internal chamber, wherein egg receiver assembly may be opened for inserting the egg into the internal chamber;
a discharge tube having a puncture end that punctures the egg when it is inserted into the internal chamber, the discharge tube extending downwardly from the puncture end to a discharge end for passage of the contents of the egg;
an air inlet tube extending inwardly from the upper portion of the internal chamber, the air inlet tube having a puncture end that punctures the egg when it is positioned within the internal chamber and the upper portion is closed;
a pneumatic system for pushing the contents of the egg out the discharge tube;
a tray positioned beneath the discharge end of the discharge tube for catching the content of the egg; and
a heating element adjacent the tray for cooking the egg.

2. The egg cooking machine of claim 1, wherein the tray is disposable.

3. The egg cooking machine of claim 1, wherein the tray is constructed of aluminum foil.

4. The egg cooking machine of claim 1, wherein the tray is constructed of steel.

5. The egg cooking machine of claim 1, wherein the heating element includes a timer that automatically stops the cooking of the egg after a predetermined time.

6. The egg cooking machine of claim 1, wherein the egg receiver assembly is mounted on a housing having a door for accessing the tray after the egg has been cooked.

7. An egg cooking machine for receiving, extracting, and cooking a single egg, the egg cooking machine comprising:
an egg receiver assembly having an upper portion and a lower portion that together form an internal chamber, wherein egg receiver assembly may be opened for inserting the egg into the internal chamber;
a discharge tube having a puncture end that punctures the egg when it is inserted into the internal chamber, the discharge tube extending downwardly from the puncture end to a discharge end for passage of the contents of the egg;
an air inlet tube extending inwardly from the upper portion of the internal chamber, the air inlet tube having a puncture end that punctures the egg when it is positioned within the internal chamber and the upper portion is closed, and wherein the air inlet tube extends from the puncture end to a lower end that communicates with the discharge tube for passage of gas into the egg;
a pneumatic system for pushing the contents of the egg out the discharge tube;
a tray positioned beneath the discharge end of the discharge tube for catching the content of the egg after being pneumatically forced out of the egg's shell and dispensed out of the discharge tube; and
a heating element adjacent the tray for cooking the egg.

8. The egg cooking machine of claim 7, wherein the tray is disposable.

9. The egg cooking machine of claim 7, wherein the tray is constructed of aluminum foil.

10. The egg cooking machine of claim 7, wherein the tray is constructed of steel.

11. The egg cooking machine of claim 7, wherein the heating element includes a timer that automatically stops the cooking of the egg after a predetermined time.

12. The egg cooking machine of claim 7, wherein the egg receiver assembly is mounted on a housing having a door for accessing the tray after the egg has been cooked.
